(19) United States
(12) Patent Application Publication
(10) Pub. No.: US 2012/0313984 A1
(43) Pub. Date: Dec. 13, 2012

(54) DISPLAY DEVICE, DISPLAY MANAGEMENT SYSTEM, AND MANAGEMENT METHOD

(75) Inventors: Motonobu Mihara, Kawasaki (JP); Masayoshi Shimizu, Hadano (JP)

(73) Assignee: FUJITSU LIMITED, Kawasaki-shi (JP)

(21) Appl. No.: 13/590,497

(22) Filed: Aug. 21, 2012

Related U.S. Application Data
(63) Continuation of application No. PCT/JP2010/052900, filed on Feb. 24, 2010.

(51) Int. Cl. G09G 5/10

(52) U.S. Cl. 345/690

(57) ABSTRACT

A display device includes: light sources that emit light in accordance with light emission currents, respectively, and that have overlapping illuminated areas illuminated with the emitted light; and a management unit that stores, as usage history, the amount of light emission current used by each of the light sources in association with the usage period. Accordingly, in the display device including the light sources arranged advantageously with respect to the manufacturing cost, the lives of the light sources can be extended by reducing the power consumption.

### CROSS-REFERENCE TO RELATED APPLICATION

This application is a continuation of International Application No. PCT/JP2010/052900, filed on Feb. 24, 2010, the entire contents of which are incorporated herein by reference.

### FIELD

The embodiments discussed herein are related to a display device.

### BACKGROUND

Some liquid crystal display devices include a liquid crystal panel and a light source (backlight) that supplies light to the back surface of the liquid crystal panel. A liquid crystal display device in which a back light is turned on to display the content of the display on a liquid crystal panel is referred to as a transmissive liquid crystal display device. In a transmissive liquid crystal display device, if direct sunlight irradiates the liquid crystal panel, the illuminance of the liquid crystal panel is too bright. This leads to the direct sunlight falling on the liquid crystal panel and thus there is a problem of the image quality deteriorating.

There is a technology in which, in order to inhibit deterioration of the image quality, both lighting of the back light and an external light are used as the light source to display content of a display on a liquid crystal panel. A liquid crystal display device using this technology is referred to as a semi-transmissive liquid crystal display device. However, in a semi-transmissive liquid crystal display device, because the external light in addition to the backlight is used as the light source, there is a disadvantage in that the power consumption and the manufacturing cost increase.

There is a transmissive liquid crystal display device in which light sources are formed such that they are arranged in a line. In the liquid crystal display device, in order to inhibit image quality deterioration, the luminance of the back light is increased by increasing the number of light sources or increasing the light emission current. In other words, because the illuminance of the liquid crystal panel is too bright when direct sunlight irradiates the liquid crystal panel, the image quality deterioration is inhibited by increasing the luminance of the backlight according to the illuminance of the liquid crystal panel. This liquid crystal display device is advantageous in that the manufacturing cost can be reduced compared to a semi-transmissive liquid crystal display device that controls the external light used as the light source.
Patent Document 1: Japanese Laid-open Patent Publication No. 2009-025437
Patent Document 2: Japanese Laid-open Patent Publication No. 2008-042060
Patent Document 3: Japanese Laid-open Patent Publication No. 2008-311008
Patent Document 4: Japanese Laid-open Patent Publication No. 2006-091433

### SUMMARY

According to an aspect of an embodiment, a display device includes a plurality of light sources and a management unit. The plurality of light sources emit light in accordance with light emission currents, respectively, and have overlapping illuminated areas illuminated with the emitted light. The management unit manages a usage history of the light emission current of each of the light sources.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a functional block diagram depicting a configuration of a display device according to a first embodiment;

FIG. 2 is a functional block diagram depicting a configuration of a display device according to a second embodiment;

FIG. 3 is a table depicting an exemplary data structure of a light emission current usage amount storage unit;

FIG. 4 is a flowchart of a procedure for adjusting the light emission intensity;

FIG. 5 is a flowchart of a procedure for managing LED life;

FIG. 6 is a flowchart of a procedure for managing light emission current adjustment;

FIG. 7 is a diagram illustrating a specific example of managing light emission current adjustment;

FIG. 8 is a diagram illustrating a specific example of managing LED life;

FIG. 9 is a diagram illustrating a duty ratio;

FIG. 10 is a flowchart of a procedure for adjusting the light emission intensity by using the duty ratio;

FIG. 11 is a diagram illustrating adjustment of the light emission intensity at the border of between bright and dark areas;

FIG. 12 is a functional block diagram depicting a configuration of a display device according to a third embodiment; and

FIG. 13 is a flowchart of a procedure for adjusting the light emission intensity.

### DESCRIPTION OF EMBODIMENTS

The liquid crystal display device in which light sources are formed such that they are arranged in a line has a problem in that, when the illuminance of the liquid crystal panel is too bright, the luminance of the back light increases according to the illuminance, which increases the power consumption of the backlight, which in turn shortens the life of the backlight accordingly.

For this reason, for liquid crystal display devices including light sources arranged advantageously with respect to the manufacturing cost, it is an important objective to extend the life of the backlight by reducing the power consumption of the backlight.

Preferred embodiments of the present invention will be explained with reference to accompanying drawings. The embodiments do not limit the invention.

### [a] First Embodiment

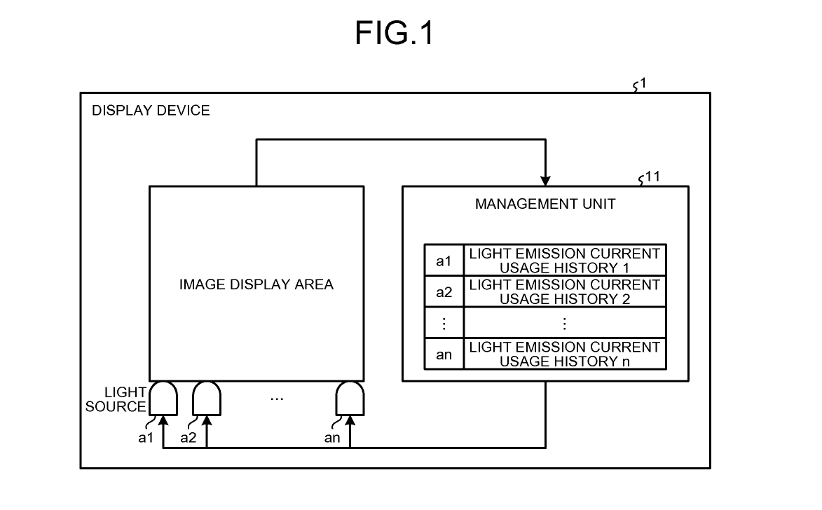

FIG. 1 is a functional block diagram depicting a configuration of a display device according to a first embodiment. As depicted in FIG. 1, a display device 1 includes light sources a1 to an; and a management unit 11.

The light sources a1 to an emit light according to the light emission current and have overlapping illuminated areas that are illuminated with the emitted light. For the light sources, for example, light emitting diodes (LED) can be used. The management unit 11 manages the usage history of the light emission current of each of the light sources a1 to an.

As described above, because the display device 1 manages the light emission currents of the light sources a1 to an over time, it can adjust the current value of the light emission current appropriately. Because the display device 1 manages the usage history of the light emission currents of the light sources a1 to an over time, it can also manage the lives of the light sources a1 to an continuously. Accordingly, the display device 1 can reduce the power consumption of the display device a1 to an and extend the lives of the light sources a1 to an.

### [b] Second Embodiment

Configuration of Display Device According to Second Embodiment

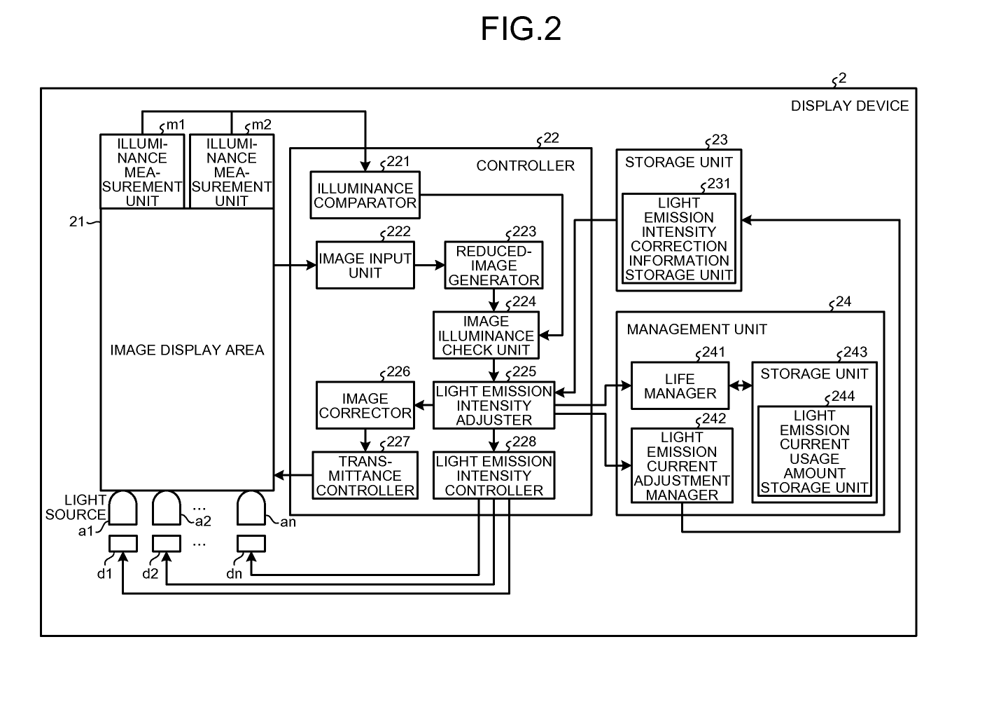

FIG. 2 is a functional block diagram depicting a configuration of a display device according to a second embodiment. As depicted in FIG. 2, a display device 2 includes light sources a1 to an, drivers d1 to dn, illuminance measurement units m1 and m2, an image display area 21, a controller 22, a storage unit 23, and a management unit 24.

The image display area 21 is, for example, a liquid crystal panel. The image display area 21 changes the transmittance of light of each pixel. The light sources a1 to an are, for example, light emitting diodes (LEDs). The light sources a1 to an emit light from the back surface to the image display area 21 and have overlapping illuminated areas on the image display area 21 that are irradiated with the emitted light. In the display device 2, the light sources a1 to an are arranged in a line along one of the sides of the image display area 21 (the bottom side in FIG. 2). By arranging the light sources a as described above, approximately uniform luminance over the surface can be obtained if light sources are emitting light. Furthermore, the number of light sources can be reduced to reduce the cost of parts.

The drivers d1 to dn drive the light sources a1 to an in accordance with the values of the light emission currents indicated by the controller 22. In the example in FIG. 2, pairs of a light source a and a driver d are provided. Alternatively, a configuration may be employed in which a driver drives light sources a.

The illuminance measurement units m1 and m2 are, for example, illuminance sensors. The illuminance measurement units m1 and m2 measure the illuminance of external light. In the display device 2, the illuminance measurement units m1 and m2 are arranged on both sides of the top side of the image display area 21, respectively. The controller 22 includes an illuminance comparator 221, an image input unit 222, a reduced-image generator 223, an image illuminance check unit 224, a light emission intensity adjuster 225, an image corrector 226, a transmittance controller 227, and a light emission intensity controller 228.

The illuminance comparator 221 compares the illuminance measured by the illuminance measurement unit m1 and the illuminance measured by the illuminance measurement unit m2 and informs the image illuminance check unit 224 of the result of the comparison. The image input unit 222 receives an input of an image to be displayed from the image display area 21 and temporarily stores the received input image in the storage unit 23. Here, the size of the input image is 800×400.

The reduced-image generator 223 generates a reduced image of the input image received by the image input unit 222. For example, the reduced-image generator 223 generates a reduced image of the illuminated area of each light source a from the input image with a size of 800×400. If there are 24 light sources a, the reduced-image generator 223 generates reduced images with a size of approximately 33×400. The reduced-image generator 223 may generate a reduced image by using a system such as a bilinear system.

The image illuminance check unit 224 checks the illuminance of the image area of each reduced image that is reduced by the reduced-image generator 223. Specifically, the image illuminance check unit 224 calculates the illuminance of each image area of each reduced image from the result of the comparison performed by the illuminance comparator 221 and checks whether the image area is a bright area or a dark area. The image illuminance check unit 224 determines whether the illuminance of each image area of each reduced image is equal to or greater than a reference value. When the illuminance is equal to or greater than the reference value, the image illuminance check unit 224 determines that the image area is a bright area. When the illuminance is less than the reference value, the image illuminance check unit 224 determines that the image area is a dark area. The reference value indicates a border value of illuminance regarded as bright or regarded as dark. The border value can be checked beforehand by a test, etc.

The light emission intensity adjuster 225 adjusts the light emission intensity by controlling the light emission current of each of the light sources a1 to an according to the illuminance. In the second embodiment, a case will be described in which, when direct sunlight irradiates the image display area 21, the light emission intensity adjuster 225 controls the light emission current of each of the light sources a. For example, when an image area (illuminated area) of a reduced image is a bright area, the light emission intensity adjuster 225 increases the light emission current such that the light emission current is greater than a standard value according to a light emission intensity correction information storage unit 231. When the image area of the reduced image is a dark area, the light emission intensity adjuster 225 reduces the light emission current such that the light emission current is less than the standard value according to the light emission intensity correction information storage unit 231. Furthermore, when no bright area exists in any of the image areas of reduced images, the light emission intensity adjuster 225 sets the standard value as the light emission current. The standard value of light emission current is the value of the rated current.

The light emission intensity correction information storage unit 231 stores information on the correction of the light emission current corresponding to the illuminance. Specifically, the light emission intensity correction information storage unit 231 stores corrected values of the light emission current for bright areas or dark areas. For a bright area, the corrected value is greater than the standard value. For a dark area, the corrected value is less than the standard value. For example, for a bright area, the light emission intensity correction information storage unit 231 stores the value obtained by the standard value×(1+α/10) as the corrected value of the bright area in order to correct the light emission current to a value greater than the standard value and obtained by multiplying the standard value by (1+α/10) where a indicates a positive real number greater than “0” and equal to or less than “10”. In other words, the light emission current is corrected by a value between the standard value and a value double that the standard value at maximum. For a dark area, the light emission intensity correction information storage unit 231 stores the value obtained by the standard value×(1−β/10) as the corrected value in order to correct the light emission current to a value less than the standard value and obtained by multiplying the standard value by (1−β/10) where β indicates a positive real number greater than “0” and equal to or less than “10”. In other words, the light emission current is corrected by a value between 0 and the standard value. The corrected value may be, as described above, an effective value that may be used for correction or a ratio with respect to the standard value. The light emission intensity correction information storage unit 231 is described as one that stores the corrected values for dark areas and bright areas. Alternatively, the light emission intensity correction information storage unit 231 may store corrected values in accordance with graded illuminance values.

The image corrector 226 corrects each pixel of the input image according to the corrected value of the light emission current of each of the light sources a, which is the light emission current adjusted by the light emission intensity adjuster 225. Specifically, because the relation indicating that “the luminance is proportional to the pixel value raised to the power 2.2” is commonly used, the image corrector 226 calculates the corrected pixel value according to Equation (1):

corrected pixel value=uncorrected pixel value×(1/fading rate)̂(½·2) (1)

The transmittance controller 227 controls the transmittance of each pixel of the image display area 21 according to each pixel of the input image, which is a pixel value corrected by the image corrector 226. The light emission intensity controller 228 informs each driver d of the value of the light emission current that is adjusted by the light emission intensity adjuster 225. As a result, each of the light source a emits light having intensity corresponding to the light emission current adjusted by the light emission intensity adjuster 225. The storage unit 23 stores, in a similar way to the light emission intensity correction information storage unit 231, various types of information which may be used for operations of the controller 22.

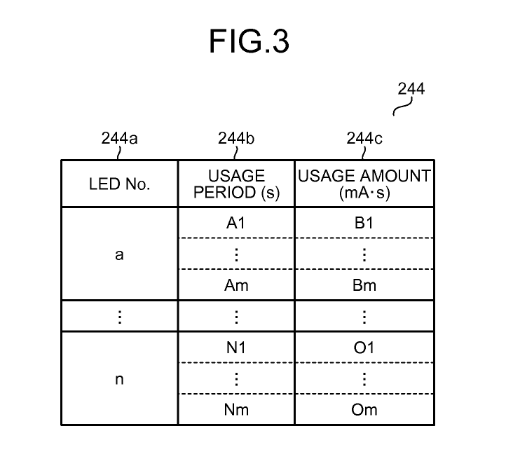

The management unit 24 includes a life manager 241, a light emission current adjustment manager 242, and a storage unit 243 including a light emission current usage amount storage unit 244. The life manager 241 stores, as usage history, the amount of light emission current used by each of the light sources a in the light emission current usage amount storage unit 244. The light emission current usage amount storage unit 244 is a storage unit that stores, as the usage history, the amount of light emission current used by each of the light sources a in association with the usage period. The data structure of the light emission current usage amount storage unit 244 will be described with reference to FIG. 3.

FIG. 3 is a table depicting an exemplary data structure of the light emission current usage amount storage unit. As depicted in FIG. 3, the light emission current usage amount storage unit 244 stores each LED No. 244a in association with usage period 244b and usage amount 244c. The LED No. 244a indicates the identification number of the light source. The usage period 244b indicates the period in which the same light emission current value is successively used. The usage amount 244c indicates the amount of light emission current used in each usage period 244b. The usage amount is the value obtained by multiplying the usage period 244b by the light emission current value.

The following section refers back to the description of FIG. 2. Specifically, upon receiving the light emission current value of each of the light sources a, which is the light emission current value adjusted by the light emission intensity adjuster 225, the life manager 241 stores, in the storage unit 243, the time when the light emission current value is received and the light emission current value as the history of each of the light sources a. At the time when the light emission current value changes, the life manager 241 calculates, according to the history, the length of the successive period in which the light emission current value was the same before the light emission current value changed. The life manager 241 then calculates the value obtained by multiplying the length of the successive period by the light emission current value as the usage amount. The life manager 241 then stores the calculated amount of light emission current usage and the calculated length of the successive period in association with a corresponding light source a in the light emission current usage amount storage unit 244.

According to the usage history stored in the light emission current usage amount storage unit 244, the life manager 241 calculates the integrated value of the amount of light emission current used by each of the light sources a and determines whether the integrated value of the amount of light emission current usage exceeds a usage limit value. In other words, the life manager 241 manages the life of each of the light sources a. When the integrated value of the amount of light emission current usage exceeds the usage limit value, the life manager 241 determines that the life of light source has come to its end and issues an alarm.

The light emission current adjustment manager 242 calculates the average value of light emission currents of the light sources a that are adjusted in the same period by the light emission intensity adjuster 225 and adjusts the light emission current of each of the light sources a such that the average value does not exceed the rated current value (standard value). Specifically, the light emission current adjustment manager 242 receives the adjusted light emission current values of the respective light sources a from the light emission intensity adjuster 225 and temporarily stores the adjusted light emission current values in the storage unit 243. The light emission current adjustment manager 242 sums all the light emission current values of the light sources a, which are temporarily stored, and acquires the quotient obtained by dividing the sum by the number of the light sources a to obtain the light emission current average value.

In addition, the light emission current adjustment manager 242 determines whether the light emission current average value is equal to or less than the rated current value (standard value). When the light emission current average value exceeds the rated current value (the standard value), the light emission current adjustment manager 242 determines that the current is over-used and changes the light emission current of each of the light sources a. For example, the light emission current adjustment manager 242 changes the corrected value for a bright area to a value less than the corrected value for bright area stored in the light emission intensity correction information storage unit 231. The light emission current adjustment manager 242 further changes the corrected value for a dark area to a value greater than the corrected value for a dark area stored in the light emission intensity correction information storage unit 231. It is satisfactory if any one of the corrected value for a dark area and the corrected value for a bright area is changed. In contrast, when the light emission current average value is equal to or less than the rated current value (standard value), the light emission current adjustment manager 242 determines that the amount of current usage is within an allowable range and maintains the value of the light emission current.

Procedure for Adjusting Light Emission Intensity

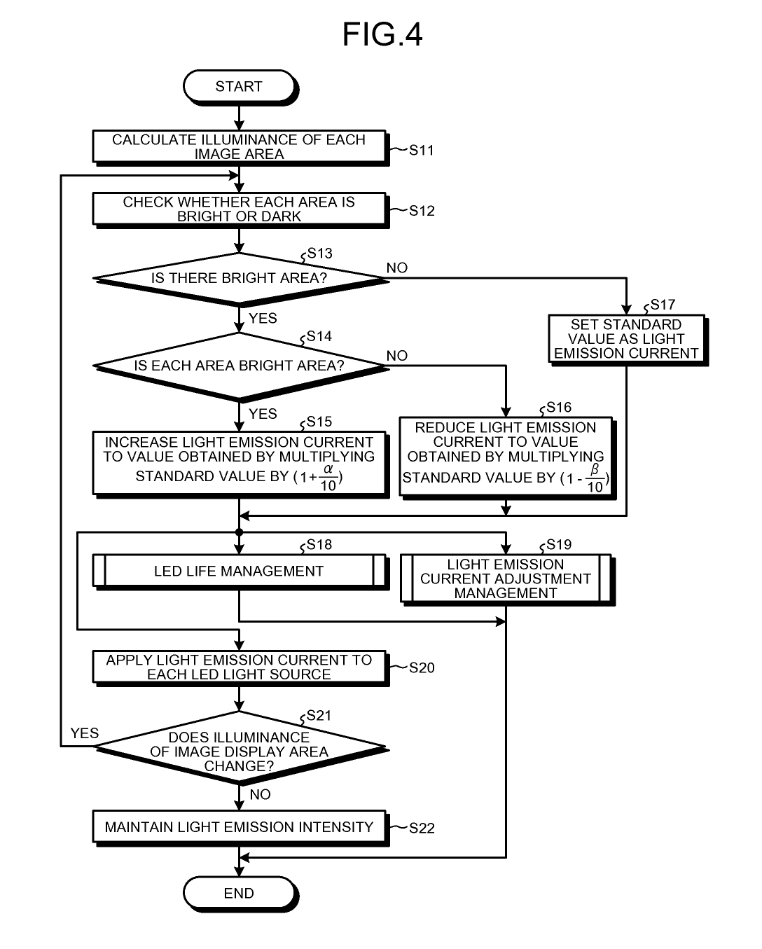

A procedure for adjusting light emission intensity according to the second embodiment will be described with reference to FIG. 4. FIG. 4 is a flowchart of a procedure for adjusting the light emission intensity.

The illuminance comparator 221 compares illuminances of external light that are measured by the illuminance measurement units m1 and m2 and informs the image illuminance check unit 224 of the result of the comparison. The image illuminance check unit 224 then calculates the illuminance of each image area of each reduced image from the comparison result (step S11). The image illuminance check unit 224 then checks whether the image area of each reduced image is bright or dark (step S12). The reduced image is a reduced image of an illuminated area of each light source a and is generated by the reduced-image generator 223.

The image illuminance check unit 224 determines whether there is a bright area in any of the image areas of the reduced images (step S13). When the image illuminance check unit 224 determines that there is a bright area in any of the image areas of reduced images (YES at step S13), the image illuminance check unit 224 determines for each image area whether it is a bright area (step S14). When it is determined that an image area is a bright area (YES at step S14), the light emission intensity adjuster 225 increases the light emission current to a value greater than the standard value by a according to the light emission intensity correction information storage unit 231 (step S15). In contrast, when it is determined that an image area is a dark area (NO at step S14), the light emission intensity adjuster 225 reduces the light emission current to a value less than the standard value by β according to the light emission intensity correction information storage unit 231 (step S16).

When the image illuminance check unit 224 determines that there is no bright area in any of the image areas (NO at step S13), the standard value is set as the light emission current (step S17).

The life manager 241 manages the life of each of the light sources a (step S18). The light emission current adjustment manager 242 calculates the average value of the light emission currents of the light sources a that are adjusted in the same period and adjusts the light emission current of each of the light sources a such that the average value does not exceed the standard value (step S19). The light emission intensity controller 228 gives the value of light emission current of each of the light sources a, which is the light emission current adjusted by the light emission intensity adjuster 225, to each of the drivers d. Each driver d applies the light emission current to the light source a according to the given value of the light emission current (step S20).

The illuminance comparator 221 then determines whether the illuminance of the image display area 21 changes (step S21). When the illuminance of the image display area 21 changes (YES at step S21), the process moves on to step S12 in order to adjust the light emission intensity. In contrast, when the illuminance of the image display area 21 does not change (NO at step S21), the light emission intensity is maintained (step S22).

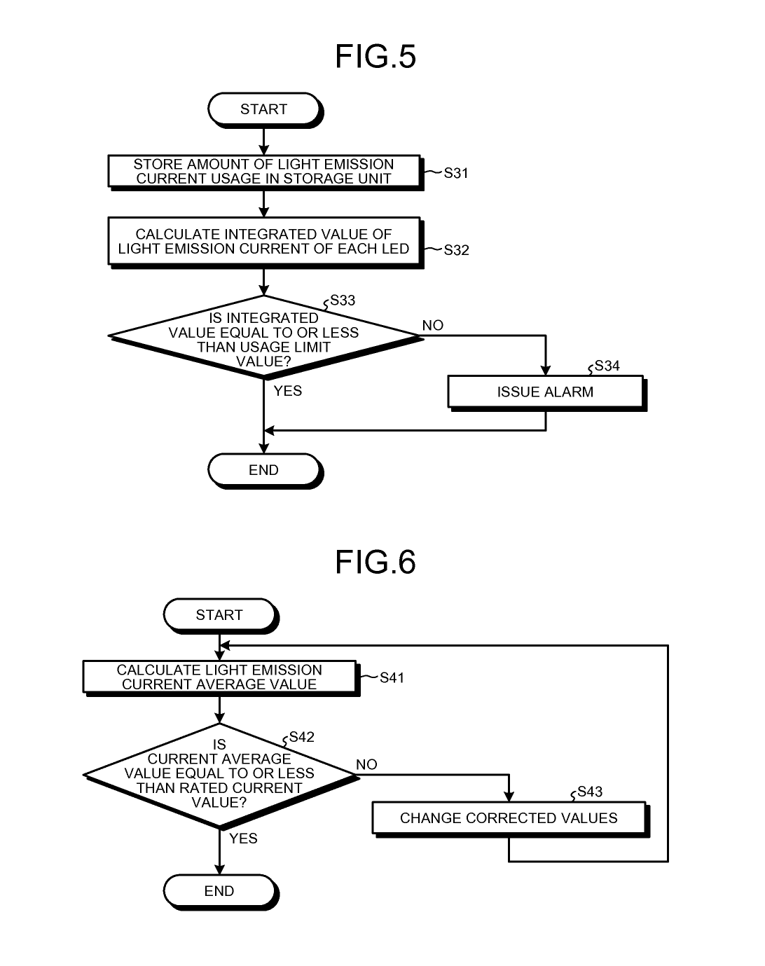

The procedure for managing LED life (S18) depicted in FIG. 4 will be described using FIG. 5. FIG. 5 is a flowchart of the procedure for managing LED life.

The life manager 241 stores the amount of light emission current used by each of the light sources a as the usage history in the light emission current usage amount storage unit 244 (step S31). The life manager 241 then calculates, with respect to each of the light sources a, the integrated value of the amount of light emission current usage from the usage history stored in the light emission current usage amount storage unit 244 (step S32).

The life manager 241 determines, with respect to each of the light sources a, whether the integrated value of amount of light emission current usage is equal to or less than the usage limit value (step S33). In other words, the life manager 241 manages the life of each of the light sources a. When the integrated value of the amount of light emission current usage is equal to or less than the usage limit value (YES at step S33), the life manager 241 keeps allowing the use of the LED. In contrast, when the integrated value of the amount of light emission current usage exceeds the usage limit value (NO at step S33), the life manager 241 determines that the life of the light source a has come to its end and issues an alarm (step S34).

The procedure for managing light emission current adjustment (S19) depicted in FIG. 4 will be described using FIG. 6. FIG. 6 is a flowchart of the procedure for managing light emission current adjustment.

The light emission current adjustment manager 242 calculates an average value of the light emission currents of the light sources a that are adjusted in the same period by the light emission intensity adjuster 225 (step S41). The light emission current adjustment manager 242 then determines whether the light emission current average value is equal to or less than the rated current value (standard value) (step S42).

When the light emission current adjustment manager 242 determines that the light emission current average value exceeds the rated current value (standard value) (NO at step S42), the corrected values stored in the light emission intensity correction information storage unit 231 are changed (step S43). This is for adjusting the light emission current of each of the light sources a such that the light emission current average value is equal to or less than the rated current value (standard value). In contrast, when the light emission current adjustment manager 242 determines that the light emission current average value is equal to or less than the rated current value (standard value) (YES at step S42), the LED keeps emitting light.

Specific Example of Managing Light Emission Current Adjustment

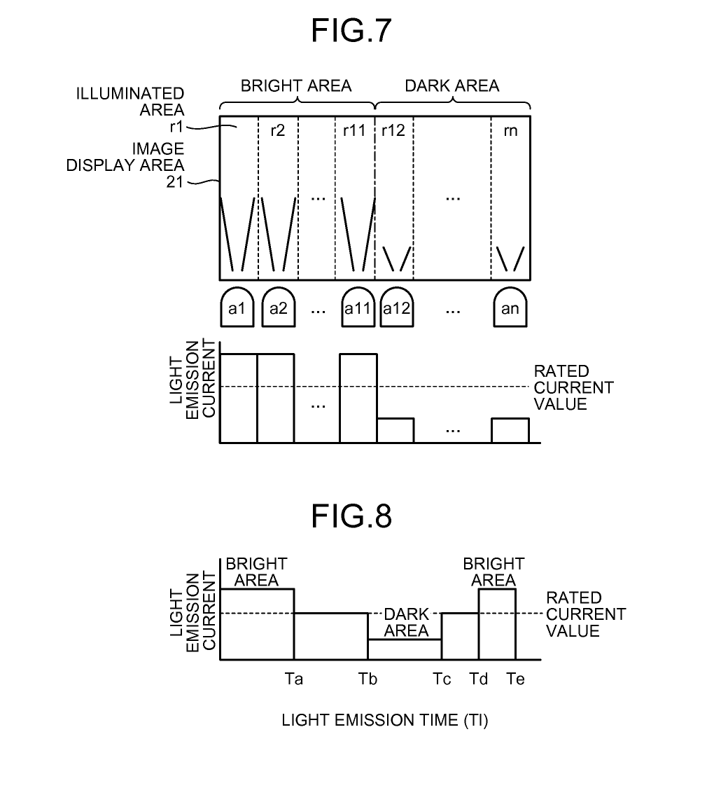

A specific example of managing light emission current adjustment will be described with reference to FIG. 7. FIG. 7 is a diagram illustrating a specific example of managing light emission current adjustment. As depicted in FIG. 7, the light sources a1 to an are arranged in a line along the bottom side of the image display area 21. In the image display area 21, there are bright areas with bright illuminance and dark areas with dark illuminance. In FIG. 7, illuminated areas r1 to r11 of the light sources a1 to all, respectively, in the image display area 21 are bright areas and illuminated areas r12 to rn of the light sources a12 to an, respectively, in the image display area 21 are dark areas.

The light emission intensity adjuster 225 adjusts the light emission current of each of the light sources a1 to an in accordance with the illuminance. Specifically, for the illuminated areas r1 to r11 that are bright areas, the light emission intensity adjuster 225 increases the light emission current to a value greater than the rated current value (standard value) according to the light emission intensity correction information storage unit 231. For example, the light emission intensity adjuster 225 corrects the light emission currents to values each greater than the rated current value (standard value) and obtained by multiplying the rated current value by (1+α/10). For the illuminated areas r12 to rn, which are dark areas, the light emission intensity adjuster 225 reduces the light emission current to a value less than the rated current value (standard value) according to the light emission intensity correction information storage unit 231. For example, the light emission intensity adjuster 225 corrects the light emission currents to values each less than the rated current value (standard value) and obtained by multiplying the rated current value by (1−β/10).

The light emission current adjustment manager 242 makes adjustments such that the average value of the light emission currents of the light sources a, which are the light emission currents that are adjusted by the light emission intensity adjuster 225, does not exceed the rated current value (standard value). Specifically, the light emission current adjustment manager 242 calculates the average value of the light emission currents of the light sources a adjusted by the light emission intensity adjuster 225. The light emission current adjustment manager 242 then determines whether the calculated light emission current average value is equal to or less than the rated value (standard value). When the light emission current adjustment manager 242 determines that the calculated light emission current average value exceeds the rated value (standard value), the light emission current value of each of the light sources a is changed.

For example, the light emission current adjustment manager 242 stores, in the light emission intensity correction information storage unit 231, (1+γ/10)×standard value, which replaces (1+α/10)×standard value, in order to correct the light emission currents for the illuminated areas r1 to r11, which are bright areas, to values each greater than the rated current value and obtained by multiplying the rated current value (standard value) by (1+γ/10) (γ<α). Furthermore, the light emission current adjustment manager 242 stores, in the light emission intensity correction information storage unit 231, (1−ε/10)×standard value, which replaces (1−β/10)×standard value, in order to correct the light emission currents of the illuminated areas r12 to rn, which are dark areas, to values each less than the rated current value and obtained by multiplying the rated current value (standard value) by (1−ε/10)(ε<β). Accordingly, the light emission intensity adjuster 225 can adjust the light emission current value of each of the light sources a such that the light emission current average value does not exceed the rated current value (standard value).

Specific Example of Managing LED Life

A specific example of managing the LED life will be described with reference to FIG. 8. FIG. 8 is a diagram illustrating a specific example of managing the LED life. As depicted in FIG. 8, the relationship between light emission time and light emission current of one light source (LED a) is indicated. Because the area illuminated by the LED a is a bright area in the light emission time Ta, the LED a emits light in accordance with the light emission current greater than the rated current value (standard value). Because the not illuminated area is a bright area between the light emission times Ta and Tb, the LED a emits light in accordance with the rated current. Because the area illuminated by the LED a is a dark area between the light emission times Tb and Tc, the LED a emits light in accordance with the light emission current less than the rated current value (standard value). Similarly, the LED a emits light in accordance with the light emission current adjusted according to whether the area illuminated by the LED a is a bright area or a dark area.

In such a case, the life manager 241 stores the amount of light emission current usage, which is obtained by multiplying the light emission time Ta by the light emission current value, in association with the light emission time “Ta” in the light emission current usage amount storage unit 244. The life manager 241 further stores the amount of light emission current usage, which is obtained by multiplying the light emission time “Tb−Ta” by the light emission current value, in association with the light emission time “Tb−Ta” in the light emission current usage amount storage unit 244. The life manager 241 further stores the amount of light emission current usage, which is obtained by multiplying the light emission time “Tc−Tb” by the rated current value, in association with the light emission time “Tc−Tb” in the light emission current usage amount storage unit 244. Similarly, the life manager 241 stores the amount of light emission current usage, which is obtained by multiplying a light emission time by the rated current value, in association with the light emission time in the light emission current usage amount storage unit 244.

The life manager 241 calculates an integrated value of the amount of light emission current usage and performs management such that the integrated value does not exceed the usage limit value. When the integrated value exceeds the usage limit value, the life manager 241 issues an alarm indicating that the life of the light source has come to its end.

Effects of Second Embodiment

According to the second embodiment, the life manager 241 stores, as the usage history, the amount of light emission current used by each of the light sources a in association with the period of use in the light emission current usage amount storage unit 244. The life manager 241 calculates the integrated value of the amount of light emission current usage from the usage history stored in the light emission current usage amount storage unit 244 and performs management such that the integrated value does not exceed the usage limit value.

This configuration allows the life manager 241 to store the amount of light emission current used by each of the light sources a over time and easily monitor the life of each of the light sources a.

According to the second embodiment, the light emission intensity adjuster 225 adjusts the light emission current of each of the light sources a in accordance with the illuminance measured by the illuminance measurement unit m. The light emission current adjustment manager 242 calculates the average value of light emission currents of the respective light source units a, which are light emission currents adjusted in the same period by the light emission intensity adjuster 225, and adjusts the light emission current of each of the light sources a such that the average value does not exceed the rated current value (standard value).

This configuration allows the light emission current adjustment manager 242 to adjust each light emission current such that the average value of the light emission currents used by the light sources a does not exceed the rated current value (standard value) at any time, which reduces the power consumption of the light sources a compared to a case in which the light emission current is not adjusted. Accordingly, the light emission current adjustment manager 242 can extend the lives of the light sources a.

Even if direct sunlight irradiates the image display area 21 and thus a bright area is caused in the image display area 21, the light emission current adjustment manager 242 adjusts the light emission currents of the light sources a in accordance with the illuminance and in accordance with the average value of the light emission currents of all the light sources a. Accordingly, direct sunlight can be prevented from falling onto the image of the bright area and thus the image quality does not deteriorate.

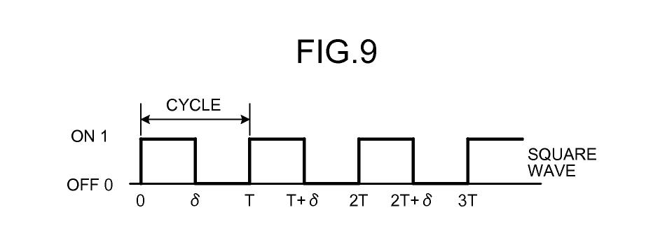

The light emission intensity adjuster 225 adjusts the value of the light emission current of each of the light sources a in order to adjust the light emission intensity. However, the light emission intensity adjuster 225 is not limited to this. The light emission intensity adjuster 225 may adjust the duty ratio of each of the light sources a in order to adjust the light emission intensity. The duty ratio is the ratio of light emission period per unit period, i.e., the ratio of time in which the light source is on to when the light source is off. The duty ratio will be described with reference to FIG. 9. FIG. 9 is a diagram illustrating a duty ratio. In FIG. 9, “1” indicates a light emission state in which the light source turns on and “0” indicates a light emission stop state in which the light source turns off. As depicted in FIG. 9, on and off are regularly indicated in one cycle. If a cycle is T, “δ” is an on period and “T−δ” is an off period. In this case, the duty ratio is “δ/T”. In other words, the on period extends as the duty ratio increases, and thus the light emission intensity increases and the light source becomes bright. In contrast, the on period shortens as the duty ratio decreases, and thus the light emission intensity decreases and the light source becomes dark. The LED cycle T is, for example, within the range of between a few tens of milliseconds (ms) and a few hundreds of milliseconds. Note that the duty ratio is a value within the range of between 10 percent (%) and 90%.

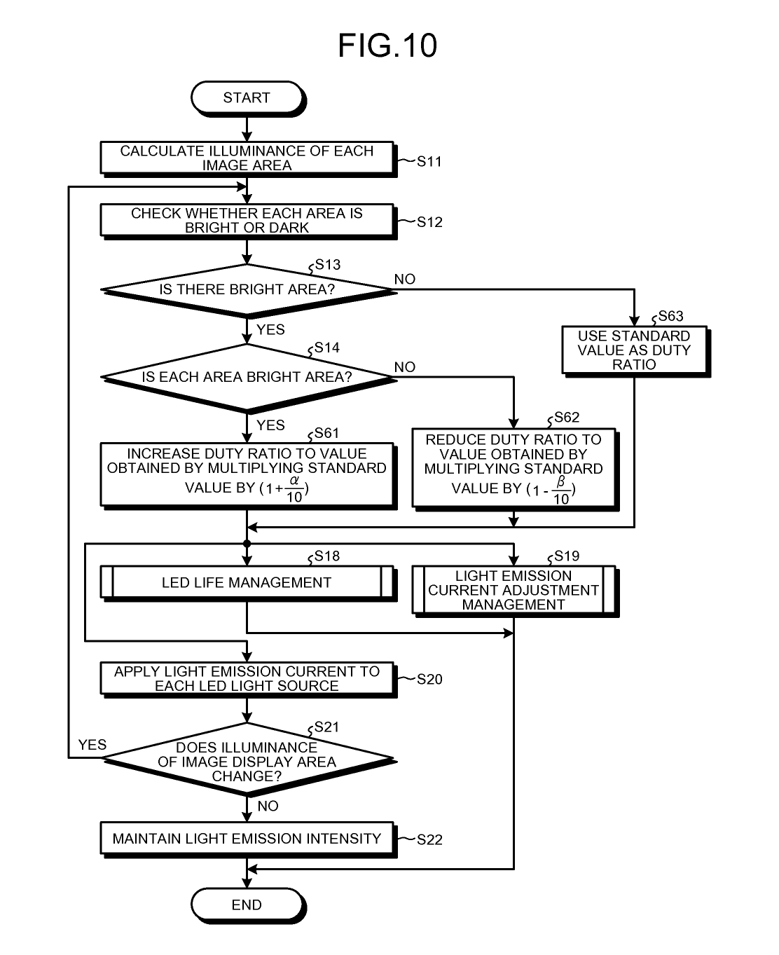

The procedure for adjusting the light emission intensity by using the duty ratio will be described with reference to FIG. 10. FIG. 10 is a flowchart of the procedure for adjusting the light emission intensity by using the duty ratio. The same processes of the procedure for adjusting the light emission intensity by using the duty ratio as those of the procedure for adjusting the light emission intensity according to the second embodiment (FIG. 4) are denoted by the same reference numbers and redundant descriptions will be simplified.

The image illuminance check unit 224 checks whether the image area of each reduced image is bright or dark on the basis of the illuminances of outer light measured by the illuminance measurement units m1 and m2 (steps S11 and S12). The image illuminance check unit 224 determines whether there is a bright area in any of the image areas of reduced images (step S13). When the image illuminance check unit 224 determines that there is a bright area in any of the image areas (YES at step S13), the image illuminance check unit 224 determines for each image area whether it is a bright area (step S14).

When it is determined that the image area is a bright area (YES at step S14), the light emission intensity adjuster 225 increases the duty ratio of light emission current to a value greater than the standard value and obtained by multiplying the standard value by (1+α/10) according to the light emission intensity correction information storage unit 231 (step S61). In contrast, when it is determined that the image area is a dark area (NO at step S14), the light emission intensity adjuster 225 reduces the duty ratio of light emission current to a value less than the standard value and obtained by multiplying the standard value by (1−β/10) (step S62). When the image illuminance check unit 224 determines that there is no bright area in any of the image areas (NO at step S13), the duty ratio of light emission current is used as the standard value (step S63). The standard value is, for example, “0.5”.

The life manager 241 manages the life of each of the light sources a (step S18). The light emission current adjustment manager 242 calculates the average value of light emission currents of the light sources a that are adjusted in the same period and adjusts the duty ratio of light emission current of each of the light sources a such that the average value does not exceed the standard value (step S19).

The light emission intensity controller 228 gives the duty ratios of light emission current of the light sources a adjusted by the light emission intensity adjuster 225 to the respective drivers d. Each driver d applies light emission currents to the light sources a on the basis of the given duty ratios (step S20). When the illuminance of the image display area 21 changes, the illuminance comparator 221 moves on to step S12 in order to adjust the light emission intensity. When the illuminance of the image display area 21 does not change, the illuminance comparator 221 maintains the light emission intensity (steps S21 and S22).

As described above, the light emission intensity adjuster 225 may adjust the light emission intensity by using the duty ratio instead of the value of light emission current. In either case, because the light emission current adjustment manager 242 adjusts the duty ratio such that the average value of light emission currents used by the light sources a does not exceed the rated value (standard value) at any time, the power consumption of the light sources a can be reduced compared to a case in which the duty ratio is not adjusted. Accordingly, the light emission current adjustment manager 242 can extend the lives of the light sources a.

### [c] Third Embodiment

Regarding the display device 2 according to the second embodiment, a case is described in which, when direct sunlight irradiates the image display area 21, the light emission current of each of the light sources a is adjusted in accordance with the illuminance. In other words, by increasing, for bright areas with bright illuminance, the light emission current to a value greater than the rated current value (standard value) and reducing, for dark areas with dark illuminance, the light emission current to a value less than the rated current (standard value), the image quality of the image display area 21 is prevented from being deteriorated due to direct sunlight. The display device 2 is not limited to this. In normal use in which no direct sunlight irradiates the image display area 21, if there are bright areas and dark areas, the light emission current for the bright area at the border of bright and dark areas may be adjusted to a value greater than the light emission current corresponding to the illuminance.

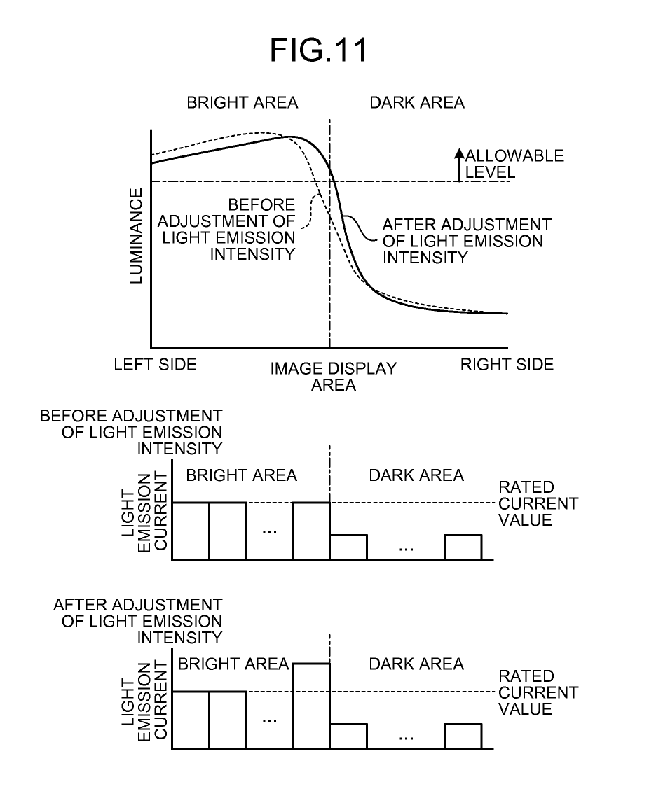

The necessity, when there are bright areas and dark areas in normal use, to adjust the light emission current for the bright area at the border of the bright areas and dark areas will be described with reference to FIG. 11. FIG. 11 is a diagram illustrating the adjustment of the light emission intensity at the border of bright and dark areas. As depicted in FIG. 11, the X axis indicates the position of the illuminated area of each of the light sources in the image display area 21 and the Y axis indicates the luminance of the illuminated area. In FIG. 11, the left side of the image display area 21 includes bright areas and the right side of the image display area 21 includes dark areas.

There is a method for the light emission intensity adjuster 225 to prevent the image quality from being reduced by setting the rated current value (standard value) as the light emission current for bright areas and by reducing the light emission current to a value less than the standard value for dark areas. However, because the illuminated areas illuminated by the light emitted by the light sources overlap at the border of bright and dark areas, adjustment of light emission intensity of the dark area side reduces the light emission intensity of the bright area side to a value less than the standard value, which reduces the luminance of the bright area side. For this reason, it is preferable to adjust the light emission current in order to increase the light emission intensity of the bright area side to increase the luminance of the bright area side at the border of the bright areas and the dark areas. FIG. 11 depicts change in luminance before light emission intensity adjustment and after light emission intensity adjustment. According to FIG. 11, after the light emission intensity of the bright area side is adjusted at the border of the bright areas and the dark areas, the luminance of the bright area side becomes greater than the luminance before the light emission intensity adjustment, so the luminance of the bright area is equal to or greater than an allowable level. Accordingly, the image quality at the border of bright and the dark areas can be prevented from being reduced.

Thus, in the third embodiment, a case will be described in which, when there are bright areas and dark areas in normal use, a display device 3 adjusts the light emission current of the bright area at the border of bright and dark areas to a value grater than the light emission current corresponding to the illuminance.

Configuration of Display Device According to Third Embodiment

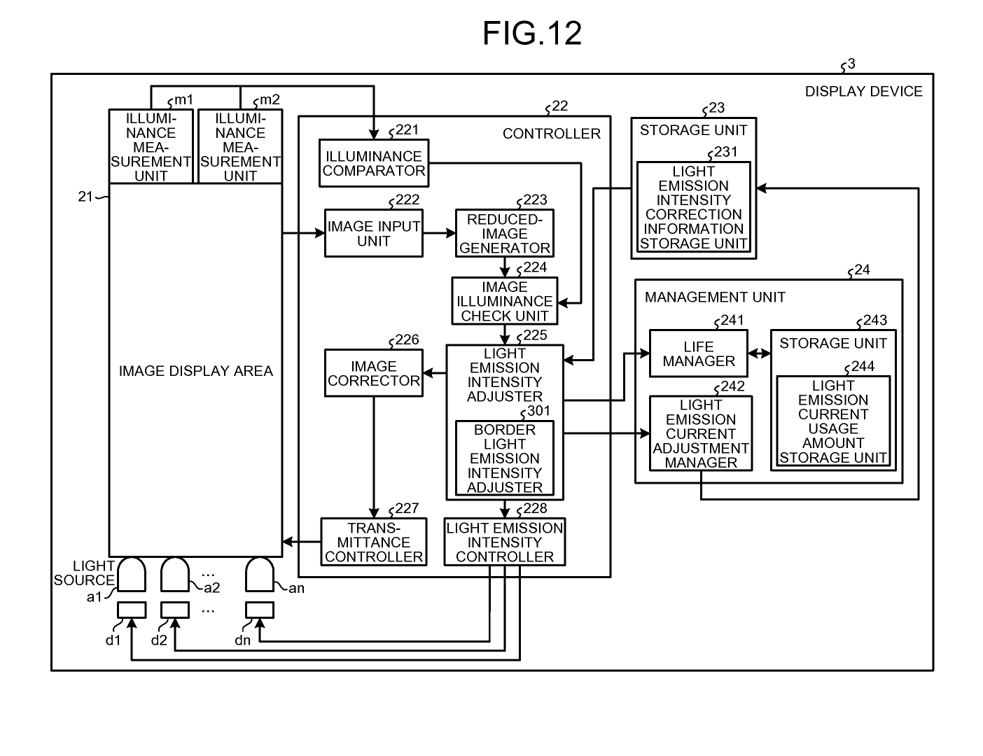

FIG. 12 is a functional block diagram depicting a configuration of the display device 3 according to the third embodiment. The same components as those of the display device 2 depicted in FIG. 2 are denoted by the same reference numbers and redundant descriptions of components and operations will be omitted. The third embodiment is different from the second embodiment in that the light emission intensity adjuster 225 includes a border light emission intensity adjuster 301.

When the illuminated areas of adjacent light sources a among the light sources a are divided into bright and dark areas, the border light emission intensity adjuster 301 controls the light emission currents such that the light emission current relating to the illuminated area on the bright area side is greater than the light emission current corresponding to the illuminance. In the third embodiment, a case will be described in which the border light emission intensity adjuster 301 controls the light emission current of each of the light sources a in normal use. Specifically, when the image area (illuminated area) of a reduced image is a bright area, the border light emission intensity adjuster 301 sets a standard value as the light emission current. When the illuminated area is a dark area, the border light emission intensity adjuster 301 reduces the light emission current to a value less than the standard value according to the light emission intensity correction information storage unit 231. When the illuminated area is at the border of the bright areas and dark areas, the border light emission intensity adjuster 301 increases the light emission current to a value greater than the standard value according to the light emission intensity correction information storage unit 231. When there is no bright area in any of the image areas of reduced images, the border light emission intensity adjuster 301 sets the standard value as the light emission current. It is provided that the standard value of light emission current is the value of the rated current.

The light emission intensity correction information storage unit 231 stores information on the correction of the light emission intensity corresponding to the illuminance in normal use. Specifically, the light emission intensity correction information storage unit 231 stores corrected values of the light emission current for bright areas and dark areas. For a bright area at the border of bright and dark areas, the corrected value is greater than the standard value. For a dark area, the corrected value is less than the standard value. For example, for a bright area at the border of bright and dark areas, the light emission intensity correction information storage unit 231 stores the value obtained by the standard value×(1+γ/10) in order to correct the light emission current to a value greater than the rated current value and obtained by multiplying the standard value by (1+γ/10). It is provided that γ indicates a positive real number greater than “0” and equal to or less than “10”. In other words, the light emission current is corrected by a value between the standard value and a value double that of the standard value at maximum. For a dark area, the light emission intensity correction information storage unit 231 stores the value obtained by the standard value×(1−β/10) in order to correct the light emission current to a value less than the standard value and obtained by multiplying the standard value by (1−β/10), which indicates a positive real number greater than “0” and equal to or less than “10”. In other words, the light emission current is corrected by a value between 0 and the standard value. The corrected value may be, as described above, an effective value that is used for correction or a ratio with respect to the standard value. The light emission intensity correction information storage unit 231 is described as one that stores the corrected values for dark areas and bright areas. Alternatively, the light emission intensity correction information storage unit 231 may store corrected values in accordance with graded illuminance values.

The light emission current adjustment manager 242 calculates the average value of light emission currents of the light sources a that are adjusted in the same period by the border light emission intensity adjuster 301 and adjusts the light emission current of each of the light sources a such that the average value does not exceed the rated current value (standard value). Specifically, the light emission current adjustment manager 242 receives the adjusted light emission current values of the respective light sources a from the border light emission intensity adjuster 301 and temporarily stores the adjusted light emission current values in the storage unit 243. The light emission current adjustment manager 242 sums all the light emission current values of the light sources a, which are temporarily stored, and acquires the quotient obtained by dividing the sum by the number of the light sources a to obtain the light emission current average value.

In addition, the light emission current adjustment manager 242 determines whether the light emission current average value is equal to or less than the rated current value (standard value). When the light emission current average value exceeds the rated current value (the standard value), the light emission current adjustment manager 242 determines that the current is over-used and changes the light emission current of each of the light sources a. For example, the light emission current adjustment manager 242 changes the corrected value for a bright area at the border of bright and dark areas to a value less than the corrected value for bright area stored in the light emission intensity correction information storage unit 231. The light emission current adjustment manager 242 further changes the corrected value for a dark area to a value greater than the corrected value for a dark area stored in the light emission intensity correction information storage unit 231. It is satisfactory if any one of the corrected value for a bright area and the corrected value for a dark area is changed. In contrast, when the light emission current average value is equal to or less than the rated current value (standard value), the light emission current adjustment manager 242 determines that the amount of current usage is within an allowable range and maintains the value of the light emission current.

Procedure for Adjusting Light Emission Intensity According to Third Embodiment

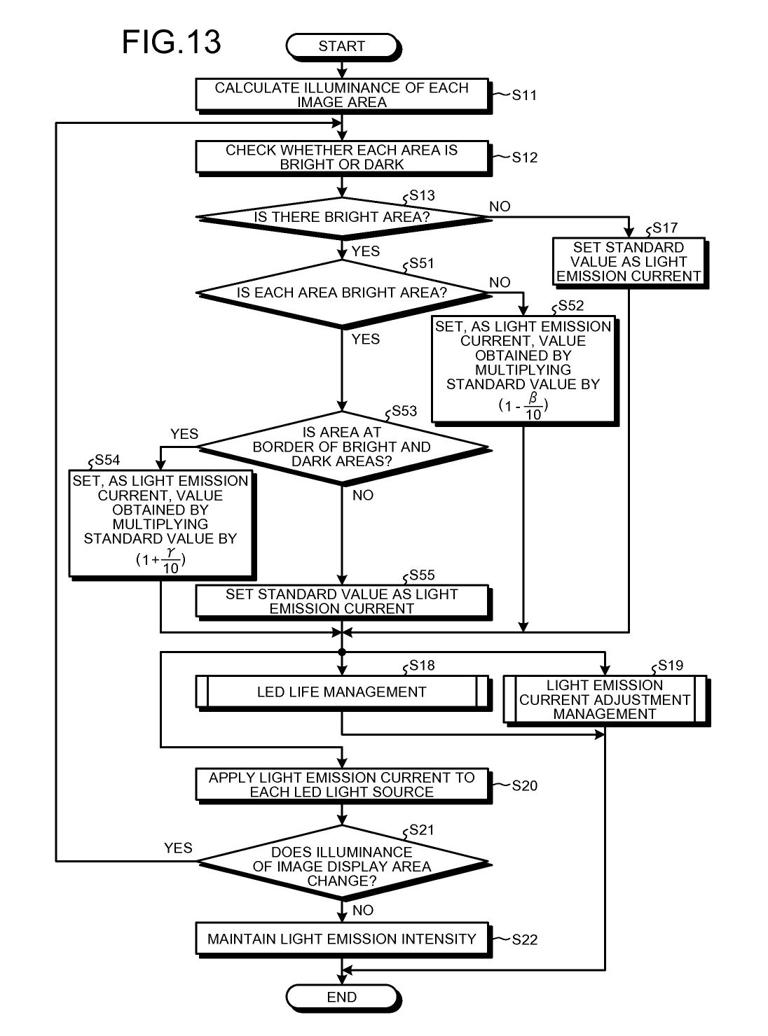

A procedure for adjusting light emission intensity according to the third embodiment will be described with reference to FIG. 13. FIG. 13 is a flowchart of a procedure for adjusting the light emission intensity. The same processes of the procedure for adjusting the light emission intensity according to the third embodiment as those of the procedure for adjusting the light emission intensity according to the second embodiment (FIG. 4) are denoted by the same reference numbers and redundant descriptions will be simplified.

The illuminance comparator 221 compares illuminances of external light that are measured by the illuminance measurement units m1 and m2 and informs the image illuminance check unit 224 of the result of the comparison. The image illuminance check unit 224 then calculates illuminance of each image area of each reduced image from the comparison result (step S11). The image illuminance check unit 224 then checks whether the image area of each reduced image is bright or dark (step S12). The reduced image is a reduced image of an illuminated area of each light source a and is generated by the reduced-image generator 223.

The image illuminance check unit 224 determines whether there is a bright area in any of the image areas of the reduced images (step S13). When the image illuminance check unit 224 determines that there is a bright area in any of the image areas of reduced images (YES at step S13), the border light emission intensity adjuster 301 determines for each image area whether it is a bright area (step S51).

When the border light emission intensity adjuster 301 determines that an image area is not a bright area (NO at step S51), the border light emission intensity adjuster 301 reduces the light emission current to a value less than the standard value and obtained by multiplying the standard value by (1−β/10) according to the light emission intensity correction information storage unit 231 (step S52). In contrast, when the border light emission intensity adjuster 301 determines that an image area is a bright area (YES at step S51), the border light emission intensity adjuster 301 determines whether the image area is at the border of bright and dark areas (step S53).

When the image area is at the border of bright and dark areas (YES at step S53), the border light emission intensity adjuster 301 increases the light emission current to a value greater than the standard value and obtained by multiplying the standard value by (1+γ/10) according to the light emission intensity correction information storage unit 231 (step S54). In contrast, when the image area is not at the border of bright and dark areas (NO at step S53), the border light emission intensity adjuster 301 sets the standard value as the light emission current (step S55).

The life manager 241 manages the life of each of the light sources a (step S18). The light emission current adjustment manager 242 calculates the average value of the light emission currents of the light sources a that are adjusted in the same period and adjusts the light emission current of each of the light sources a such that the average value does not exceed the standard value (step S19). The light emission intensity controller 228 gives the value of light emission current of each of the light sources a, which is the light emission current adjusted by the light emission intensity adjuster 225, to each of the drivers d. Each driver d applies the light emission current to the light source a according to the given value of light emission current (step S20).

The illuminance comparator 221 then determines whether the illuminance of the image display area 21 changes (step S21). When the illuminance of the image display area 21 changes (YES at step S21), the process moves on to step S12 in order to adjust the light emission intensity. In contrast, when the illuminance of the image display area 21 does not change (NO at step S21), the light emission intensity is maintained (step S22).

Effects of Third Embodiment

According to the third embodiment, the light sources a emit light in accordance with the light emission current and have overlapping illuminated areas that are illuminated with the emitted light. In normal use, when the illuminated area is a dark area, the border light emission intensity adjuster 301 reduces the light emission current to a value less than the standard value according to the light emission intensity correction information storage unit 231. When the illuminated areas of adjacent light sources a among the light sources a are divided into bright area and dark areas, the border light emission intensity adjuster 301 adjusts the light emission current relating to the illuminated area on the bright area side such that the light emission current is greater than the light emission current corresponding to the illuminance.

Such a configuration allows the border light emission intensity adjuster 301 to increase the luminance of the bright area side, which is the luminance that decreases due to adjustment of the light emission intensity of the dark area side, at the border of bright and dark areas. Accordingly, the border light emission intensity adjuster 301 can increase the contrast of brightness and darkness at the border of bright and dark areas, which prevents the image quality at the border of bright areas and dark areas from being reduced.

### Other Embodiments

In the third embodiment, when the illuminated areas of adjacent light sources a among the light sources a are divided into bright and dark areas, the border light emission intensity adjuster 301 adjusts the light emission current relating to the illuminated area on the bright area side such that the value of the light emission current is greater than the light emission current corresponding to the illuminance. However, the border light emission intensity adjuster 301 is not limited to this. The border light emission intensity adjuster 301 may adjust the light emission current by using the duty ratio of the light emission current instead of the value of the light emission current. In this case, when an illuminated area is a bright area, the border light emission intensity adjuster 301 sets the standard value as the duty ratio. When the illuminated area is a dark area, the border light emission intensity adjuster 301 reduces the duty ratio to a value less than the reference value according to the light emission intensity correction information storage unit 231. When the illuminated area is at the border of bright and dark areas, the border light emission intensity adjuster 301 increases the duty ratio on the bright area side to a value greater than the standard value according to the light emission intensity correction information storage unit 231. Furthermore, when there is no bright area in any of the illuminated areas, the border light emission intensity adjuster 301 sets the standard value as the duty ratio. The standard value of the duty ratio is, for example, “0.5” but is not limited to this.

The light emission current adjustment manager 242 calculates an average value (light emission current average value) of the light emission currents of the light sources a that are adjusted by the light emission intensity adjuster 225. When the average value exceeds the rated current value, the light emission current adjustment manager 242 changes the corrected values stored in the light emission intensity correction information storage unit 231. In other words, after the light emission current adjustment manager 242 changes the corrected values, the light emission intensity adjuster 225 adjusts the light emission currents by using the changed corrected values and informs the light emission intensity controller 228 of the values of the adjusted light emission currents. However, the light emission current adjustment manager 242 is not limited to this. The light emission current adjustment manager 242 may change the corrected values when the light emission current average value exceeds the rated current value, adjust the light emission currents by using the changed corrected values, and directly inform the light emission intensity controller 228 of the values of the adjusted light emission currents.

The structural components of the devices in the drawings do not always have to be physically configured as illustrated in the drawings. In other words, the specific manner of separation and integration of each device is not limited to the manner depicted in the drawings, and the entirety or part of the structural components can be functionally or physically separated or integrated in arbitrary units in accordance with various loads and usages. For example, the controller 22 and the management unit 24 may be integrated into one unit. In this case, it is preferable that the storage unit 243 of the management unit 24 is integrated with the storage unit 23. On the other hand, the life manager 241 may be separated into a usage history creation unit that creates the usage history of the light emission current of each light source and a life monitoring unit that monitors the lives of the light sources from the usage history. The management unit 24 may be connected as an external device to the display device 2 by way of a network and operate with the display device 2 to realize the functions of the display device 2 and the display device 3.

The process functions performed by the display device 2 and the display device 3 are entirely or partially realized by a CPU (central processing unit) (or a micro computer, such as a MPU (micro processing unit) or a MCU (micro controller unit)) and programs that are analyzed and executed by the CPU, or realized as hardware by wired logic.

According to an aspect of the display device disclosed by the present application, a display device including light sources arranged advantageously with respect to the manufacturing cost has an effect that the power consumption is reduced and the life of the light sources is extended.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A display device comprising:
a plurality of light sources that emit light in accordance with light emission currents, respectively, and that have overlapping illuminated areas illuminated with the emitted light; and
a management unit that manages a usage history of the light emission current of each of the light sources.

2. The display device according to claim 1, wherein the management unit includes:
a storage unit that stores, as the usage history, an amount of light emission current used by of each of the light sources in association with a usage period; and
a life manager that calculates an integrated value of the amount of light emission current used by each of the light sources from the usage history stored in the storage unit and performs management such that the integrated value does not exceed a usage limit value.

3. The display device according to claim 1, further comprising:
an illuminance measurement unit that measures the illuminance of external light; and
a controller that controls the light emission current of each of the light sources in accordance with the illuminance measured by the illuminance measurement unit,
wherein the management unit includes:
a light emission current adjuster that calculates the average value of the light emission currents of the light sources, which are light emission currents controlled in the same period by the controller, and that adjusts the light emission current of each of the light sources such that the average value does not exceed a rated current value.

4. The display device according to claim 3, wherein, when illuminated areas of adjacent light sources among the light sources are divided into a bright area and a dark area, the controller controls the light emission currents such that the light emission current relating to the illuminated area on the side of the bright area is greater than the light emission current corresponding to the illuminance.

5. The display device according to claim 3, wherein, when illuminated areas of adjacent light sources among the light sources are divided into a bright area and a dark area, the controller controls the light emission currents such that a light emission ratio obtained by defining the ratio of light emission period per unit period is greater than a light emission ratio corresponding to the illuminance.

6. A display management system comprising:
a display device including:
a plurality of light sources that emit light in accordance with light emission currents, respectively, and that have overlapping illuminated areas illuminated with the emitted light; and
a controller that controls the light emission current of each of the light sources in accordance with illuminance; and
a management device including
a management unit that manages a usage history of the light emission current of each of the light sources.

7. A management method performed by a display device to manage a plurality of light sources that have overlapping illuminated areas illuminated with emitted light, the management method comprising:
controlling, performed by the display device, controlling the light emission current of each of the light sources in accordance with illuminance; and
calculating, performed by the display device, the average value of the light emission currents of the light sources, which are light emission currents controlled in the same period by the controlling, and adjusting the light emission current of each of the light sources such that the average value does not exceed a rated current value.
